(19) United States
(12) Patent Application Publication
(10) Pub. No.: US 2019/0209966 A1
(43) Pub. Date: Jul. 11, 2019

(54) Gas-Permeable Structure with Chemically-Reactive Coating

(71) Applicant: Chrystal Jolliffe, London, OH (US)

(72) Inventor: Chrystal Jolliffe, London, OH (US)

(21) Appl. No.: 16/243,286

(22) Filed: Jan. 9, 2019

Related U.S. Application Data
(60) Provisional application No. 62/615,524, filed on Jan. 10, 2018.

(51) Int. Cl. B01D 53/86; B01D 46/00; B01D 46/52; B01D 39/12

(52) U.S. Cl. CPC B01D 53/8668; B01D 46/0038; B01D 46/521; B01D 46/0001; B01D 39/12; B01D 2255/2073; B01D 2239/045; B01D 2257/90; B01D 2255/915; B01D 2279/50; B01D 2275/10; B01D 2239/065; B01D 2239/0407; B01D 2257/708

(57) ABSTRACT

A filter with a frame and media is disclosed for removing chemical substances from air or other gas. The media has multiple slit and expanded sheet layers, or other air-permeable layers, with molecular catalyst material mounted on one or more of the layers. The air or other gas flowing through the media makes sufficient contact with the catalyst to chemical react substances therein with the catalyst to remove or greatly reduce the substances. This can be used to remove or reduce odors, formaldehyde or any other substance without substantial pressure drop due to the large openings in the layers. The layers may be pleated to give strength to the media.

### CROSS-REFERENCES TO RELATED APPLICATIONS

This application claims the benefit of U.S. Provisional Application No. 62/615,524 filed Jan. 10, 2018. The prior application is hereby incorporated by reference.

### STATEMENT REGARDING FEDERALLY-SPONSORED RESEARCH AND DEVELOPMENT

(Not Applicable)

### THE NAMES OF THE PARTIES TO A JOINT RESEARCH AGREEMENT

(Not Applicable)

### REFERENCE TO AN APPENDIX

(Not Applicable)

### BACKGROUND OF THE INVENTION

This invention relates generally to residential and commercial heating, ventilation and air conditioning (HVAC) filters, and more specifically to filters that have components that react with chemicals in a gas or airstream flowing through the filter without substantial removal of particulate from the airstream.

Conventional filters that are designed to chemically react with the airstream have a paper or aluminum honeycomb-shaped base structure. The base structure is coated with particles that react with, or adsorb, chemicals that are part of an air or gas stream. The particles remove or modify the chemicals from the gas or airstream by reacting with the chemicals. Typical of such chemicals are volatile organic chemicals (VOCs), such as formaldehyde.

Honeycomb base structures are commonly used in conventional filters, but are expensive due to manufacturing complexity. For example, honeycomb base structures are made in flat blanks with a set of heights necessary due to the low-volume production of the products that utilize such substrates. In order to have the desired product available when needed, a manufacturer must maintain a large inventory of expensive products that are time-consuming to make. Paper honeycombs also require cross-bracing to hold them in the filter frame, while an aluminum honeycomb does not. Having no cross-bracing members allows more air to pass through the filter and provides 100% utilization of the catalyst coating.

### BRIEF SUMMARY OF THE INVENTION

An open base filter structure is disclosed herein with particles attached to the structure so that the particles are exposed to the flowing air or gas. The base structure may be pleated, thereby resulting in some of the same strength and durability properties as the prior art, but at lower cost and with other advantages.

The base structure may be made of aluminum, but alternatively may be made of plastic, stiff paper or any other suitable material, including (without limitation) tinplate and galvanized steel. The base structure may be slit-and-expanded sheet material to create openings, but alternatively may be an extruded or otherwise manufactured net with openings. The open base structure may be formed by punching or otherwise removing sections of a sheet or panel to form voids. The aforementioned base structures may be made of any suitable material, including metal, plastic, paper, paperboard, and others.

The base structure may be formed into a low pressure-drop molecular filter. Such filters are not necessarily designed to remove particulate from the gas or air, but could be used in conjunction with a particulate filter. Thus, such a filter may be used as a pre-filter to a higher pressure-drop, high-efficiency particle filtration filter. The person of ordinary skill will understand that the base structure may be used alone or with any other filtration structure.

A slit-and-expanded aluminum structure has many advantages, and may be produced at a fraction of the cost of the prior art honeycomb base structures. Slitting, expanding, and then pleating aluminum to make an open base structure is more cost-effective than the prior art. An expanded aluminum material can be pleated to any desired height from a flat blank, so the inventory and time constraints of the prior art do not exist with the claimed invention. Thus, large quantities of (un-pleated) slit and expanded aluminum may be kept on hand, and when a particular height/thickness of aluminum structure is required, the aluminum may be quickly pleated to that height and mounted in a frame for use.

### BRIEF DESCRIPTION OF THE SEVERAL VIEWS OF THE DRAWINGS

FIG. 1 is a view in perspective illustrating an embodiment of the present invention.

FIG. 2 is a front view illustrating the embodiment of FIG. 1.

FIG. 3 is an end view in section illustrating the embodiment of FIG. 1 through the line A-A.

FIG. 4 is an enlarged schematic view illustrating the encircled (4) portion of FIG. 1.

FIG. 5 is a side view in section of the embodiment of FIG. 4 along the line 5-5.

FIG. 6 is a view in perspective illustrating an exemplary multiple-layered filtration media.

FIG. 7 is a view in perspective illustrating a layer of slit and expanded sheet material.

FIG. 8 is an end view illustrating multiple slit and expanded layers.

FIG. 9 is a view in perspective illustrating multiple slit and expanded layers.

FIG. 10 is a side view illustrating multiple slit and expanded layers.

FIG. 11 is an exploded view of multiple slit and expanded layers of different opening size and different orientation.

FIG. 12 is a front view illustrating multiple slit and expanded layers.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

U.S. Provisional Patent Application No. 62/615,524, which is the above-claimed priority application, is hereby incorporated by reference.

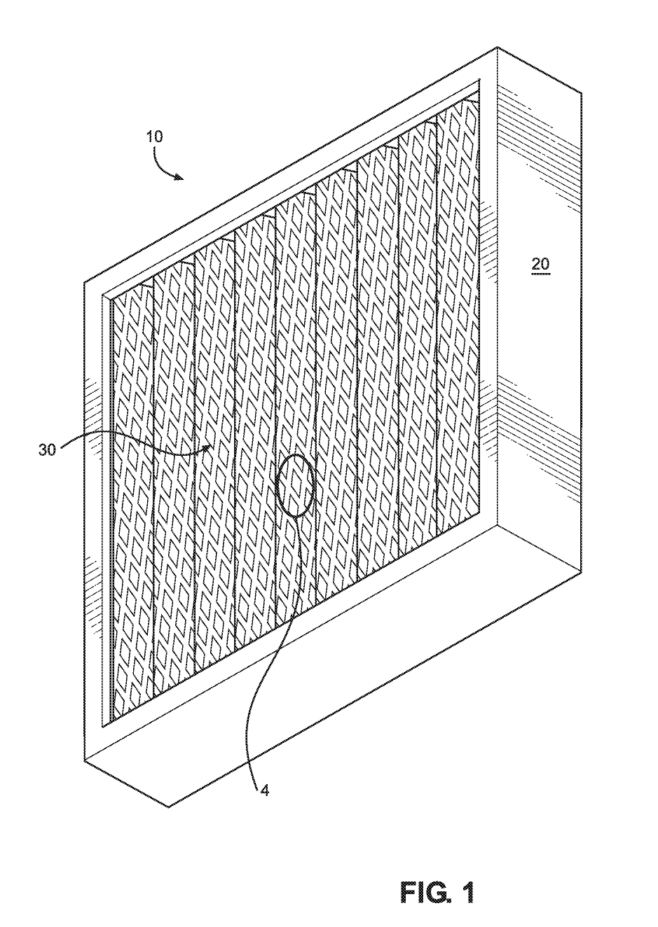

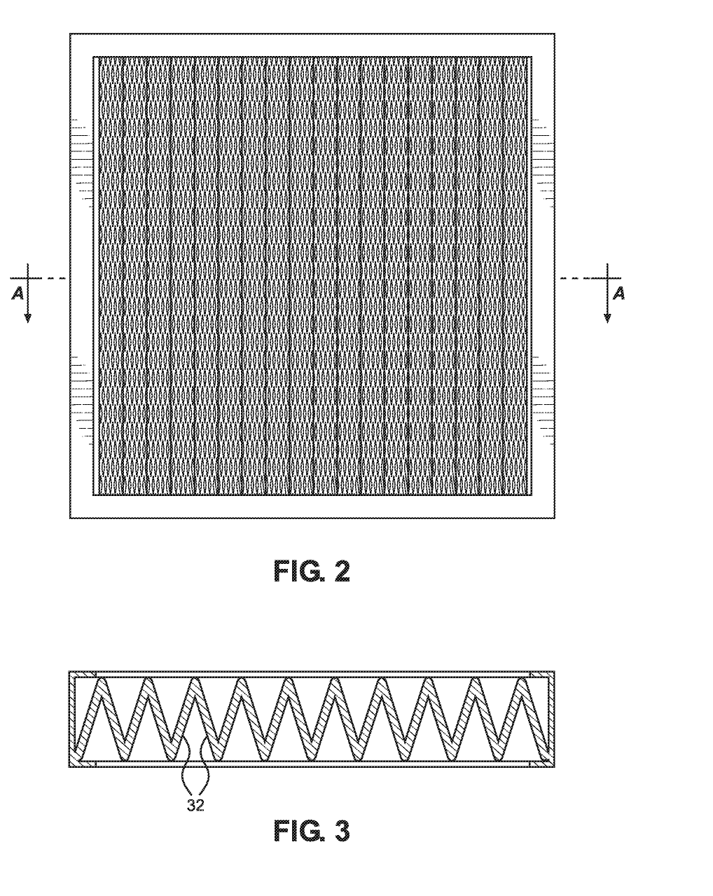

FIG. 1 shows a filter 10 including a frame 20 surrounding a filtration media 30. The frame 20 may be made of paper, plastic or any other conventional filter frame material. The main purpose of the frame 20 is conventional, including sealing the edges of the filtration media 30 so that only insubstantial amounts of air bypass the filter 10 when the filter 10 is placed in the path of a flow of gas, such as air, in an HVAC system of a home or commercial building. Such a flow path may be the kind disclosed in U.S. Pat. No. 9,943,796 (Ptak), which is incorporated herein by reference. The frame 20 may be U-shaped in cross section, as seen in FIG. 3, and made of aluminum.

The filtration media 30 may be made of two components—a base substrate material and a coating. The base substrate material may be slit and expanded material, such as paper, plastic or metal. In one embodiment, the filtration media 30 is slit and expanded aluminum sheet, which may have a thickness in a range between 0.010 inches and 0.032 inches. A typical thickness for this product may be 0.014 inches.

The filtration media 30 may be a single layer of perforated material, such as slit and expanded aluminum, or it may be made of multiple layers, each of which has openings. Multiple layers may all be the same thickness and opening size, or each layer may be different. In one embodiment, an upstream (closer to the inlet of gas into the filter 10) layer has larger openings and each next-downstream (closer to the outlet of gas from the filter 10) layer has smaller openings. The openings in adjacent layers may be aligned, or the openings may be offset to maximize the tortuosity of the pathways through the filtration media 30. It is contemplated to use different materials in different layers of the filtration media 30, such as an aluminum layer on the upstream side, a paper layer in the middle and a plastic layer on the downstream side.

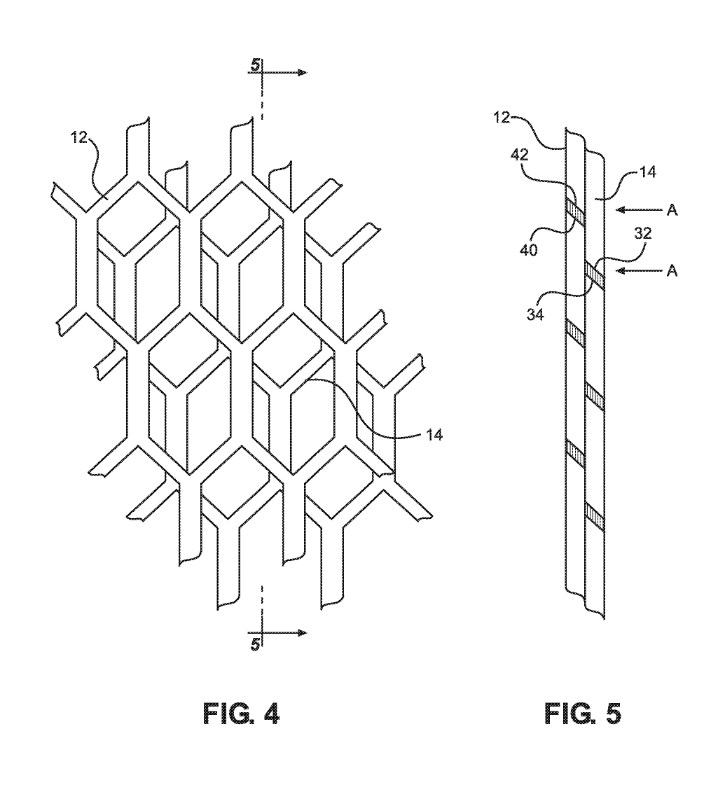

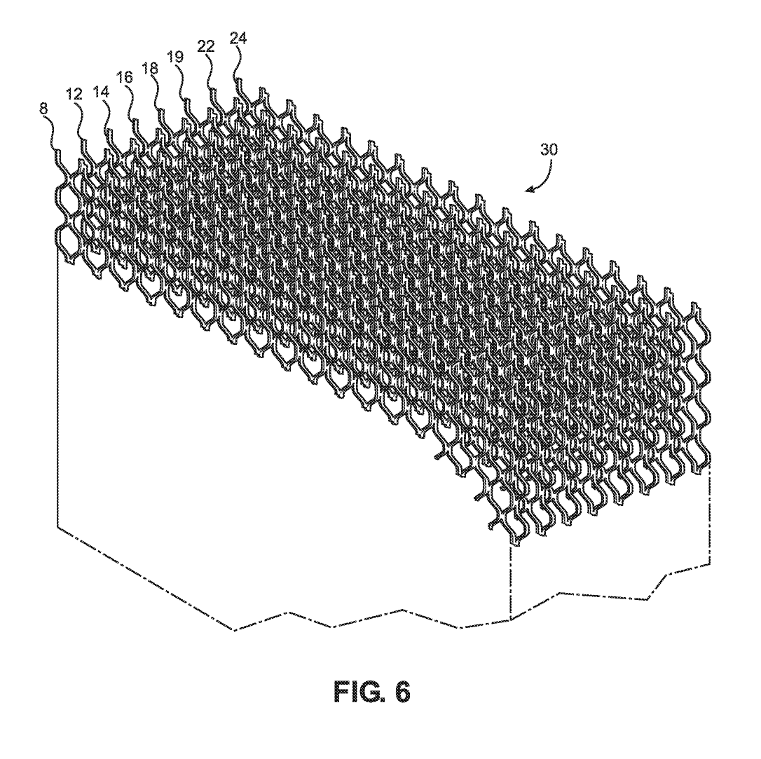

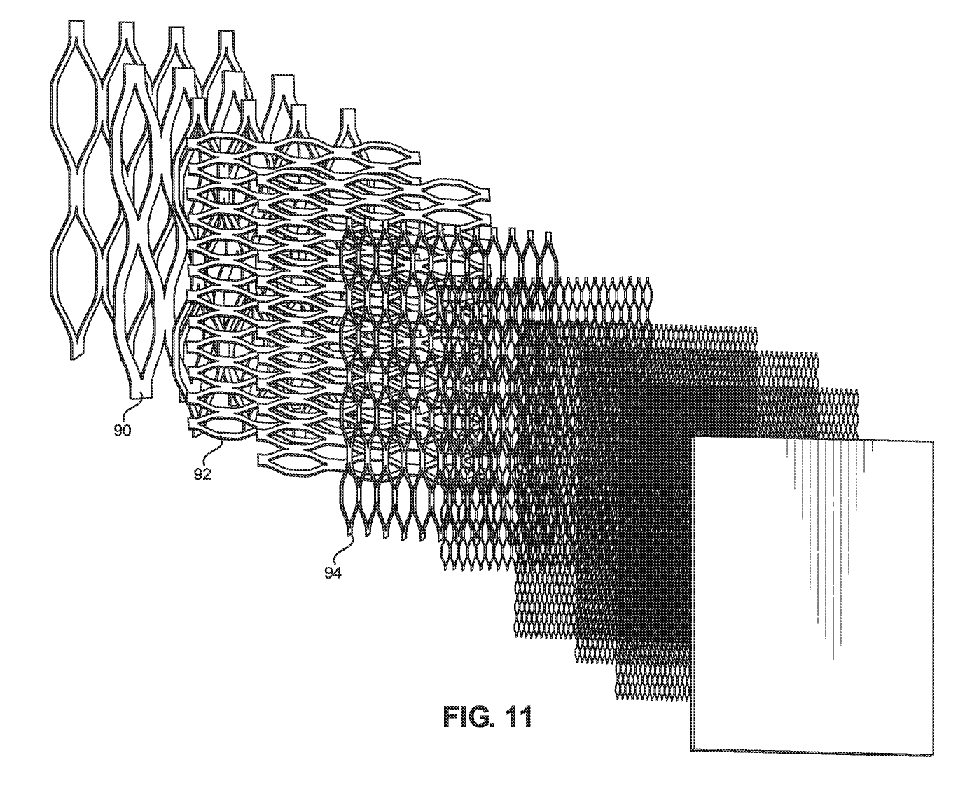

In one embodiment shown in FIGS. 4 and 5, one layer 12 of slit and expanded material has openings that are offset from the openings of an underlying layer 14 so that some members of the layer 14 cross over the openings in the layer 12. This is apparent in the side view in section of FIG. 5. Additional layers may be added to the pair of layers 12 and 14 shown in FIGS. 4 and 5 so that three, four, five or more layers may be stacked upon one another, as in the embodiment of FIG. 6. These additional layers may have openings that are the same size as those in layers 12 and 14, or the openings may be of a different size as shown in the embodiments of FIGS. 8 and 11. Furthermore, these additional layers may have openings that align with the openings of one of the layers 12 or 14, or the additional layers may have openings that are offset from the openings of adjacent layers. Still further, layers may be rotated 90 degrees from adjacent layers, as shown in FIG. 11. Slit and expanded aluminum may be manufactured with various sizes and densities of openings and various sizes and densities of connecting portions. Contemplated slit opening ranges are from at least 0.125 inches to about 2.0 inches. Opening density depends on diamond size and strand size, and contemplated densities for the slit and expanded sheet include 30%, 40%, 50%, 60%, 70%, 80%, 90% and any other amount up to about 95% of the sheet being open air. The balance is made up of the members that make up the slit and expanded sheet.

The base substrate of the filtration media may be pleated. Pleating is the folding of portions of the media 30 into a series of planar panels angled relative to next adjacent panels. The panels are arranged in an alternating, sinusoidal configuration. Pleated aluminum base structure is strong and versatile in the number of options, degrees of openness, and base substrate thicknesses. For slit and expanded media, the pleating may occur after the media is slit and expanded. Whenever desired, the base substrate may be pleated to any pleat size, including any height, any number of pleats per unit width, and any distance between peaks of next adjacent pleats that is suitable. Such a structure can withstand temperature changes and humidity changes as well as, or better than, conventional honeycomb aluminum.

The slit and expanded, and then pleated, aluminum base structure may have a molecular catalyst coating. The surfaces 32, 34, 40 and 42 of the layers 12 and 14 are given reference numerals in FIG. 5, and these and other surfaces of the layers may be coated with a molecular catalyst particulate. The molecular catalyst reacts with chemicals in the gas or air that comes into contact with the catalyst, thereby either changing the chemicals into a chemically different molecule or atom, or adsorbing the chemicals. The molecular catalysts may include impregnated or non-impregnated carbons, zeolites, potassium permanganates, the materials disclosed in United States Patent Application Publication No. 2018-0117522 to Gaur (which is incorporated herein by reference), and other conventional molecular catalysts.

The molecular catalyst is dispersed widely and preferably evenly over the media 30 to remove VOCs and other chemicals from the gas or air that is passed through the filter 10 when placed in a conventional HVAC, or other air cleaning, system, such as a room air-cleaner. The catalyst may be on only one, or more than one but still fewer than all, of the layers of the media 30. The particles may be a fine powder with a size as small as 0.007 inches. The catalyst particles, which may range in size from about 1/16 inch to about ¼ of an inch, are adhered to the base structure using conventional methods and adhesives. One method is to bathe the media in a liquid adhesive and then broadly spread catalyst particles over the media in contact with the liquid adhesive. Once the adhesive hardens, the media may be coated with adhesive, or adhesive and catalyst particles, again. The particles may be mounted by using a slurry based coating. In this process, the very small particles may be suspended in a wet solution of binder and water and then applying the slurry to the substrate, such as by dipping the substrate into the slurry for coating. The substrate and slurry are then dried.

The catalyst particles may be attached after pleating of the base structure or after forming the openings. The catalyst particles in the filter 10 are known by the person of ordinary skill, as are the methods of adhering such particles to conventional substrates, such as aluminum. Prior art methods have been found to be successful when used on the substrates described herein.

FIG. 1 shows a filter that includes the pleated, slit and expanded aluminum filtration media 30 with the base structure described above. The filtration media 30 preferably has multiple layers, with each layer having openings of similar size. FIG. 3 is a section view looking through the filter after the frame 20 has been mounted around the filtration media 30. The pleated filtration media 30 has multiple panels 32 at non-parallel angles to next adjacent panels. The media 30 extends between peaks and valleys across the frame.

Each pleat may be made up of a single layer of media, such as slit and expanded aluminum, or multiple layers of media. It is contemplated to include a combination of one or more layers of slit and expanded aluminum with one or more layers of non-aluminum filtration media, which may be in pleated or non-pleated form. It is also contemplated to include a layer of unpleated slit and expanded aluminum parallel to the plane of the filter 10.

It is contemplated that one or more of the above structures may be combined with a containment layer on one or both sides of the pleated structure in the manner of a scrim or support in order to hold more molecular catalyst particulate within the voids in the structure. This layer may be co-pleated with the aluminum structure or with a particulate filtration layer, or both. Such a containment layer creates little to no pressure drop across the entire structure, and may be made of any conventional containment layer material, including but not limited to polymer, glass, metal or any other material.

The filter 10 may be placed in an air stream that is forced through a conventional HVAC system, such as spanning across the cold air return duct of a residential or commercial forced-air HVAC system. The catalyst particles in the filter 10 react with the chemicals in the air stream to remove the chemicals from the air stream or reduce the quantity of the chemicals in the air stream, such as by adsorption. One example of a molecular catalyst is MnOx used to reduce or remove a VOC, such as formaldehyde, as described in the published patent application incorporated by reference above.

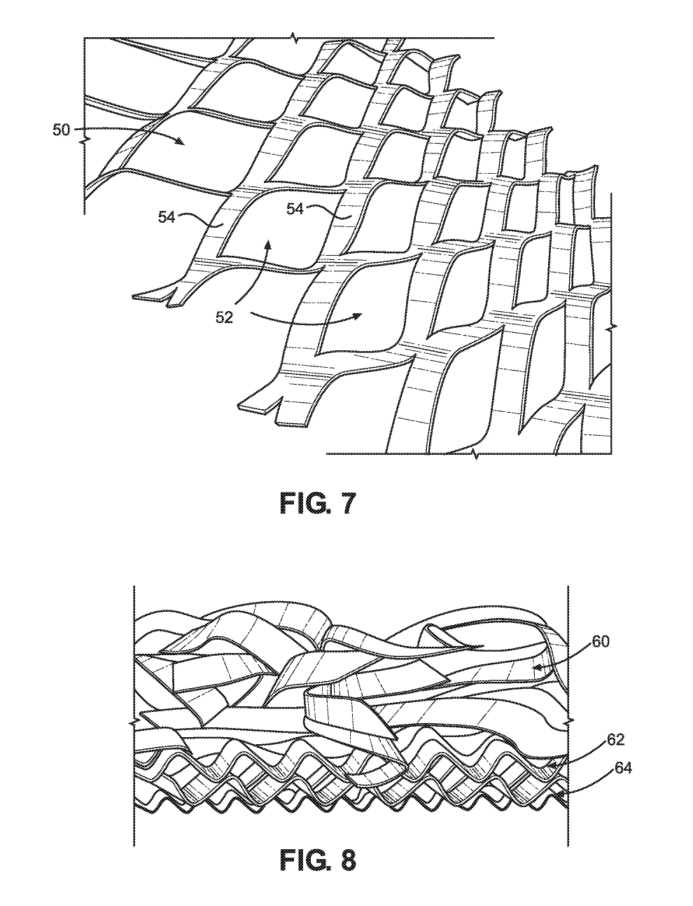

A contemplated filtration media 30 is shown in FIG. 6 having layers 8, 12, 14, 16, 18, 19, 22, and 24. Each of the layers in the media 30 is substantially the same thickness, opening size, and orientation. One layer 50 of typical slit and expanded media is shown in FIG. 7. The layer 50 has openings 52 formed by slitting the sheet of which the layer 50 is formed, and then pulling the sheet edges perpendicular to the length of the slits. This leaves curved members 54 remaining between, and defining, the openings 52.

As shown in FIG. 5, the members 54 are equivalent to the members on which the surfaces, 32, 34, 40 and 42 are formed. Thus, the members 54 are transverse to the direction of airflow, represented by the arrows designated “A” in FIG. 5. This permits molecular catalyst particles mounted to the members 54 to react with any chemical substances, such as formaldehyde, in the air as the air flows along the members 54.

As the air flows through a multi-layer filtration media 30, the air (containing one or more substances) contacts the members that are transverse to the direction of airflow and that have molecular catalysts mounted thereon, and the air is directed downstream laterally to other members that have molecular catalysts thereon. It is clear from the illustrations of FIGS. 6 and 8-12 that a multiple-layer slit and expanded filtration medium directs air through tortuous paths as the air passes through the medium, thereby assuring substantial contact by the air (and the substances therein) with the molecular catalysts on the layers. This contact ensures reaction of the substances with the molecular catalyst particles, which results in excellent results by changing the chemical composition of the substances in the air. Contact of the base structure with air passing through the media 30 is as good as, or better than, the prior art. By offsetting openings in adjacent layers, having different opening sizes in adjacent layers, or both, the contact can be improved. Furthermore, the pressure drop of the air across the media 30 is not substantial, because the openings in each layer are large. Therefore, little to no particulate is strained out of the air by the media 30.

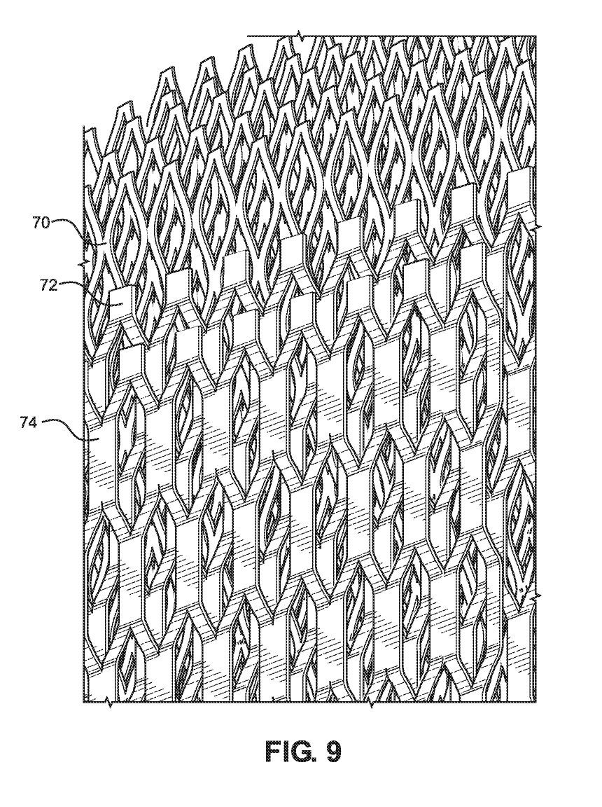

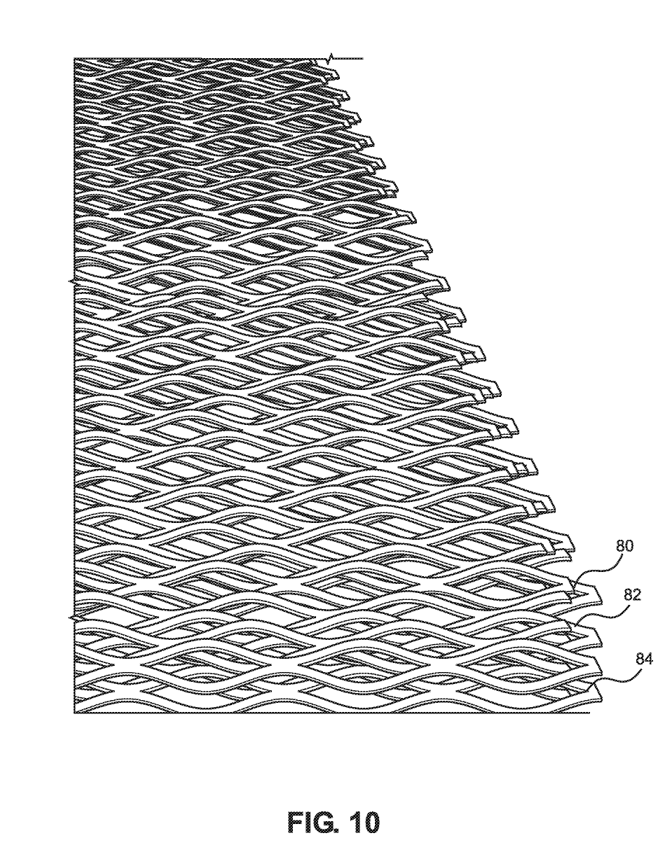

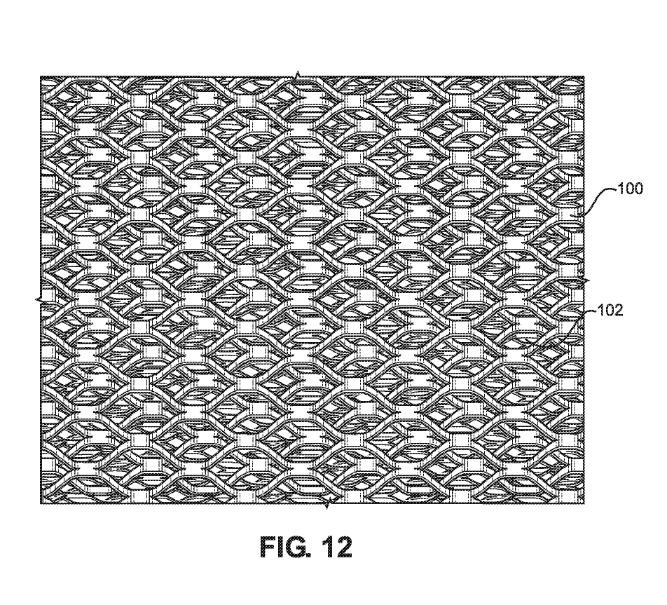

FIG. 8 shows multiple paper, slit and expanded media layers 60, 62 and 64, each of which has different sized openings. FIG. 9 shows a similar series of paper, slit and expanded media layers 70, 72 and 74 with variations in opening size. FIG. 10 shows multiple metal, slit and expanded media layers 80, 82 and 84. In FIG. 11, paper slit and expanded media layers 90, 92 and 94 are adjacent to similar layers that are oriented at a 90 degree angle to them in order to obtain the benefits of this configuration. In FIG. 12, two layers of aluminum slit and expanded layers 100 and 102 are offset from one another in a grouping of several similar layers.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A filter comprising:
(a) an air-pervious filtration media mounted within a frame, the media including at least one sheet layer having a plurality of openings through which air may pass without substantial pressure drop; and
(b) a plurality of granules mounted to the at least one sheet layer in a dispersed configuration, the granules reacting with at least one substance in the air when the at least one substance contacts the granules while passing through the media, thereby changing the chemical makeup of the air without removing substantial particulate from the air.

2. The filter in accordance with claim 1, wherein the at least one sheet layer further comprises a plurality of sheet layers, each sheet layer having a plurality of openings through which air may pass without substantial pressure drop.

3. The filter in accordance with claim 2, wherein each of the plurality of sheet layers has a plurality of granules mounted thereto in a dispersed configuration, the granules reacting with at least one substance in the air when the at least one substance contacts the granules while passing through the media, thereby changing the chemical makeup of the air without removing substantial particulate from the air

4. The filter in accordance with claim 3, wherein the openings in the plurality of sheet layers are formed by slitting and then expanding the sheet layers prior to mounting the plurality of granules to the sheet layers.

5. A filter comprising:
(a) an air-pervious filtration media mounted within a frame, the media including a plurality of sheet layers, each of the sheet layers having a plurality of openings, which are formed by slitting and then expanding the sheet layers, through which air may pass without substantial pressure drop, wherein the sheet layers are pleated to form at least a first substantially planar panel having a first edge joined at a predetermined, non-parallel angle to a first edge of a second substantially planar panel; and
(b) granules mounted to at least one of the sheet layers in a dispersed configuration, the granules reacting with at least one substance in the air when the at least one substance contacts the granules while passing through the media, thereby changing the chemical makeup of the air without removing substantial particulate from the air.

6. The filter in accordance with claim 5, wherein at least one of the sheet layers comprises aluminum.

7. A method of forming an air filter, the method comprising:
(a) slitting and expanding a plurality of sheets of aluminum;
(b) mounting molecular catalyst granules to the slit and expanded sheets of aluminum, the granules configured for reacting with at least one substance in the air when the at least one substance contacts the granules;
(c) maintaining said plurality of sheets in an inventory;
(d) removing at least one sheet from the inventory and pleating the at least one sheet to form at least a first substantially planar panel having a first edge joined at a predetermined, non-parallel angle to a first edge of a second substantially planar panel;
(e) mounting a frame around said at least one sheet after pleating.

8. The method in accordance with claim 7, further comprising passing the air through the at least one sheet, thereby changing the chemical makeup of the air without removing substantial particulate from the air.
